(19) United States
(12) Patent Application Publication
(10) Pub. No.: US 2002/0078439 A1
(43) Pub. Date: Jun. 20, 2002

(54) Digital content-data distribution

(76) Inventor: Yoko Yamaga, Yokosuka-Shi (JP)

Correspondence Address: JACOBSON HOLMAN, PROFESSIONAL LIMITED LIABILITY COMPANY, 400 Seventh Street, N.W., Washington, DC, 20004, US

(21) Appl. No.: 10/022,909

(22) Filed: Dec. 20, 2001

(30) Foreign Application Priority Data
Dec. 20, 2000 (JP) 2000-386541
Oct. 22, 2001 (JP) 2001-323250

(51) Int. Cl. H04N 7/16; H04N 7/173

(52) U.S. Cl. 725/1; 725/2; 725/5; 725/86; 725/87

(57) ABSTRACT

In distribution of digital content data via communications between an order terminal and a main server, it is decided whether digital content data be downloaded when a user places an order or later in accordance with a user request and/or capacity of a user memory for storing the digital content data. The ordered digital content data is transmitted from the main server to the order terminal when the user places an order or later in accordance with the decision. The transmitted digital content is then downloaded to the order terminal. The N (an integer of two or more) number of digital content data having the same contents but different from each other on compression ratio and/or data format are stored in a memory. When an order placement for the digital content data is accepted, the N number of digital content data are retrieved from the memory to form a set of the N number of digital content data or a set of the N number of digital content data are retrieved from the memory. A receiver is designated for receiving the set of the N number of digital content data. One or more of the N number of digital content data is transmitted to the order terminal or a sub-terminal when designated as the receiver.

### BACKGROUND OF THE INVENTION

The present invention relates to a digital content-data distribution system and a method for distributing digital content data such as music and video data.

There have been increasing demands for data-distribution services for distributing digital content data such as music and video data through networks of various communication means such as satellites, CATVs, phone lines and wireless communications using mobile phones and also for home delivery services for delivering information storage media such as CDs and DVDs storing those digital content data when users place an order through those networks.

Users usually purchase such storage media at record shops, convenience stores etc. Not only that, recently, users have access to various sites for digital-content-data distribution via terminals set at those shops or user terminals and download digital content data to user terminals or store the data on storage media through a purchase procedure with retrieval and selection of requested contents from among digital content data listed on the sites.

There are several formats for digital content data, such as MP3, ATRAC, AAC and ASF for music distribution to players for play-backing these data. In addition, there are several types for information storage media for storing digital content data such as CDs, DVDs and video tapes.

When users want to get digital content data in several formats through the services described above, he or she has to download digital content data in each format or buy several storage media, which sometimes bother users.

Moreover, when users want to get storage media storing digital content data instead of downloading, he or she has to buy the storage media or retrieve the data from the storage media and convert them into different data formats, which also bother users, and causing a problem of illegal duplication of the digital content data.

Digital content data cannot be downloaded when users do not have storage media such as memories, CD-Rs and DVD-Rs with enough storage capacity or do not have a time for downloading. Compression of digital content data to a small data amount is available for such cases, nonetheless it causes data degradation, thus users sometimes hesitate to buy digital content data. These problems could cause less chances for users to buy digital content data.

Downloading digital content data to home terminals seems to be available for users with no problems of storage capacity or downloading time. However, this also could cause a problem in that users loose eagerness for purchase due to burdensome procedures such as data retrieval and purchase proceeding.

Digital-content-data distribution systems set at record shops or convenience stores with playing music there could drive users for purchase.

Sales of digital content data at such shops, however, force users to carry information storage media of large capacity and endure a long downloading time, which could be burdensome for users. Users can buy information storage media that have already stored digital content data at those shops. However, this requires stocks of storage media storing digital content data at those shops.

### SUMMARY OF THE INVENTION

A purpose of the present invention is to provide a digital content-data distribution system and a method for distributing digital content data in which users can select, via a mobile terminal, etc, either to accept data distribution now or only acquire a right (license) to obtain content data in later distribution.

The present invention provides a digital content-data distribution system having: an order terminal for downloading digital content data in response to order placement made by a user for the digital content data via the order terminal, whether the ordered digital content data be downloaded when the user places an order or later being decided in accordance with a user request and/or capacity of a user memory for storing the ordered digital content data; and a main server for transmitting the ordered digital content data when the user places an order or later in accordance with the decision.

Moreover, the present invention provides a digital content-data distribution system having: an order terminal for downloading digital content data when a user places an order for the digital content data via the order terminal; and a main server for transmitting the ordered digital content data in response to the order placement via the order terminal, wherein the main server includes: a memory for storing N (an integer of two or more) number of digital content data having the same contents but different from each other on compression ratio and/or data format; an order-accepting unit for accepting the order placement for the digital content data; a data-retrieving unit, responsive to the order placement, for retrieving the N number of digital content data from the memory and forming a set of the N number of digital content data or retrieving a set of the N number of digital content data from the memory; a data-receiver designating unit for designating a receiver for receiving the set of the N number of digital content data; a media-selecting unit for selecting package media and/or downloadable digital-data media for obtaining the ordered set of the N number of digital content data; and a transmitter for transmitting one or more of the N number of digital content data as the downloadable digital-data media to the order terminal or a sub-terminal when designated as the receiver, the order terminal includes: an order-placing unit for placing an order for the package media and/or the downloadable digital-data media to the main server; and a receiver for receiving the downloadable digital-data media, the system further has a delivery server connected to the main server via a network, the delivery server having: a communications unit for receiving an order placement from the main server; an order-accepting unit for accepting an order for the storage media; a stock-managing unit for managing stock and a date of delivery for the ordered storage media and notifying the order-accepting unit of information on the stock and date of delivery; and a delivery unit for delivering the ordered storage media to a place designated the order-accepting unit, and the sub-terminal being connected to the main server via the network, having a receiver for receiving the downloadable digital-data media.

Furthermore, the present invention provides a method of distributing digital content data via communications between an order terminal and a main server having the steps of: deciding whether digital content data be downloaded when a user places an order or later in accordance with a user request and/or capacity of a user memory for storing the digital content data; transmitting the ordered digital content data from the main server to the order terminal when the user places an order or later in accordance with the decision; and downloading the transmitted digital content to the order terminal.

Moreover, the present invention provides a method of distributing digital content data via communications between an order terminal and a main server having the steps of: storing N (an integer of two or more) number of digital content data having the same contents but different from each other on compression ratio and/or data format in a memory; accepting an order placement for the digital content data; retrieving the N number of digital content data from the memory in response to the order placement to form a set of the N number of digital content data or retrieve a set of the N number of digital content data from the memory; designating a receiver for receiving the set of the N number of digital content data; and transmitting one or more of the N number of digital content data to the order terminal or a sub-terminal when designated as the receiver.

### BRIEF DESCRIPTION OF DRAWINGS

FIG. 1 shows a block diagram of a first embodiment of a content-data distribution system according to the present invention;

FIG. 2 is a flowchart for explaining an operation of the content-data distribution system shown in FIG. 1;

FIG. 3 is a flowchart for explaining a download procedure at a sub-terminal in the content-data distribution system shown in FIG. 1;

FIG. 4 is a flowchart for explaining a data-receiving procedure in the download procedure at the sub-terminal in the content-data distribution system shown in FIG. 1;

FIG. 5 shows a block diagram of a second embodiment of a content-data distribution system according to the present invention;

FIG. 6 is a flowchart for explaining an operation of the content-data distribution system shown in FIG. 5;

FIG. 7 illustrates formats for digital content data according to the present invention;

FIG. 8 shows a block diagram of a modification to the second embodiment of a content-data distribution system according to the present invention, provided with a network storage;

FIG. 9 shows a block diagram of a third embodiment of a content-data distribution system according to the present invention;

FIG. 10 shows a block diagram of a processor of an order terminal in the third embodiment shown in FIG. 9;

FIG. 11 shows a block diagram of a processor of a content-distribution server (main server) in the third embodiment shown in FIG. 9;

FIG. 12 is a flowchart for explaining an operation of the third embodiment shown in FIG. 9;

FIG. 13 shows a block diagram of a processor of a content-distribution server (main server) for copyright protection as a modification to the third embodiment shown in FIG. 9:

FIG. 14 shows a block diagram of a processor of a sub-terminal for copyright protection as the modification to the third embodiment shown in FIG. 9;

FIG. 15 shows a block diagram of a processor of a sub-server for copyright protection as the modification to the third embodiment shown in FIG. 9; and

FIG. 16 is a flowchart for explaining an operation for copyright protection as the modification to the third embodiment shown in FIG. 9.

### DETAILED DESCRIPTION OF PREFERRED EMBODIMENTS

Preferred embodiments of a content-data distribution system according to the present invention will be disclosed with reference to the attached drawings.

[First Embodiment]

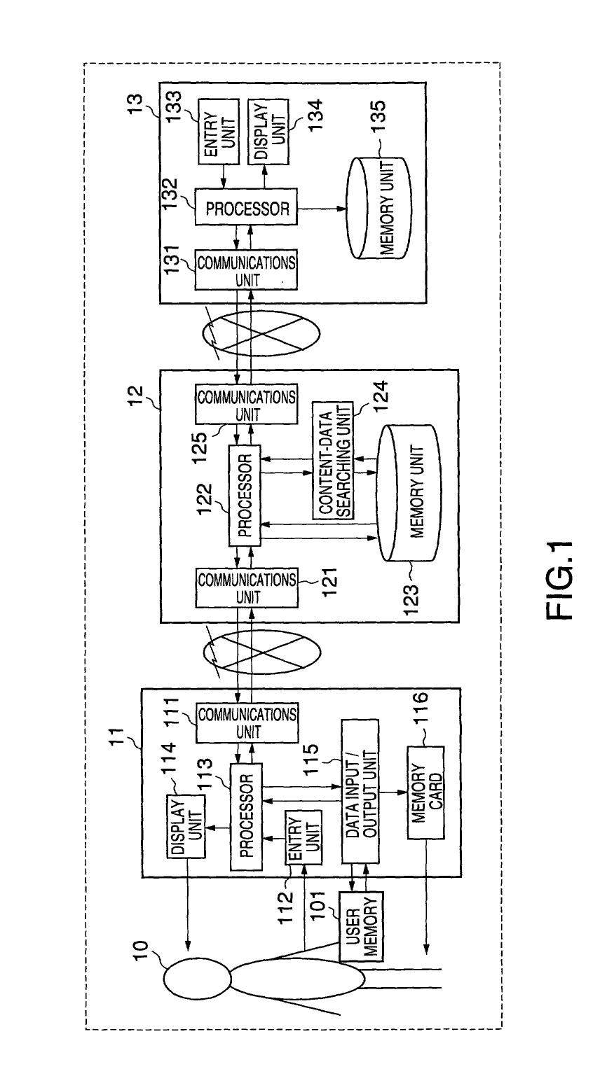

FIG. 1 shows a block diagram of a first embodiment of a content-data distribution system according to the present invention. A main terminal 11 (called order terminal hereinafter) is used for placing an order for digital content data. The order terminal 11 may be set at record shops, convenience stores or in the street. Or, it may be owned by a user 10. Another sub-terminal 13 has a memory unit 135 of large storage capacity, which may be set at the user's home. Digital content data such as music and video data are sent to the terminals 11 and 13 from a server 12 set at a content-distributing site.

The order terminal 11 is equipped with a communications unit 111 for communicating with the server 12, an entry unit 112 for placing an order for digital content data, a processor 113 for processing data for the entry unit 112, a data input/output unit 115 storing digital content data sent from the server 12 to a user memory 101 carried by the user 10 or a memory card 116 inserted into the order terminal 11, and a display unit 114 for displaying purchase and distribution interactions. The memory card 116 may be carried by the user 10 and inserted into the order terminal 11 for use. Or, empty memory cards may be stocked in the order terminal 11.

The server 12 at the content-distributing site is equipped with a communications unit 121 for communicating with the order terminal 11, a communications unit 125 for communicating with a sub-terminal 13, a processor 122 for processing data received via the communications units 121 and 125, a content-data searching unit 124 for the user 10 to retrieve digital content data, and a memory unit 123 for storing a lot of digital content data, a content database for managing the digital content data and user information to be used for user identification.

The sub-terminal 13 is equipped with a communications unit 131 for communicating with the server 12, an entry unit 133 for the user 10 to receive digital content data, a memory unit 135 for storing the received digital content data, a processor 132 for performing various procedures in this sub-terminal, and a display unit 134 for displaying the procedures.

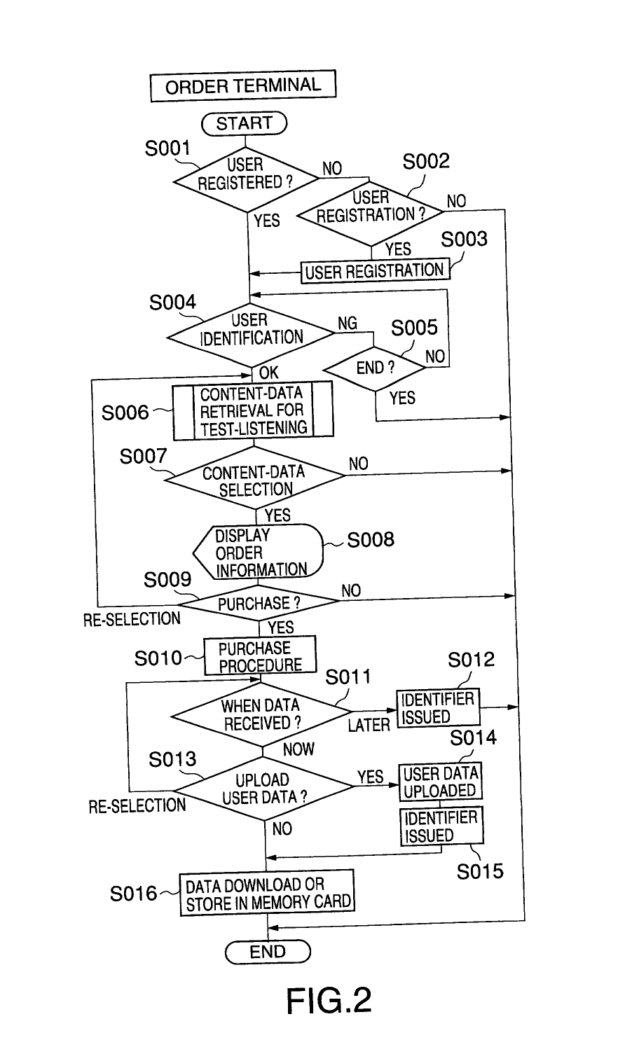

A routine for the user 10 to acquire digital content data in the first embodiment will be disclosed with reference to FIG. 1 and also FIG. 2, a flowchart for explaining an operation of the content-data distribution system shown in FIG. 1.

When the user 10 wants to buy a particular digital content data, he or she has access to the server 12 at the content-distributing site from the order terminal 11. It is checked whether the user 10 has already been registered (step S001). If registered (YES in step S001), the routine goes to a user identification procedure (step S004). On the other hand, if not registered (NO in step S001), the user 10 decides whether to register or not (step S002).

When the user 10 wants to register (YES in step S002), he or she enters user information, via the entry unit 112, such as a name, a contact address, a credit card number, an ID and a password. The user information is transmitted to the server 12 via the processor 113 and the communications unit 111 and further to the processor 121 via the communications unit 121 for a user registration procedure (step S003) and also the user identification procedure (step S004). The user identification procedure may however be omitted when just after the user registration procedure. The routine ends if the user 10 does not want to register (NO in step S002).

In the user identification procedure (step S004), the user 10 enters user identification (ID) information via the entry unit 112 of the order terminal 11. The user ID information is transmitted to the processor 122 of the server 12. The processor 122 has access to the memory unit 123 for a query procedure as to whether the entered user ID information and user information already stored in the memory unit 123 match each other (step S004).

When the user identification procedure has failed (NG in step S004), a message is displayed on the display unit 114 of the order terminal 11 to ask the user 10 whether to end the user identification procedure (step S005). If the user 10 wants to try again the procedure (NO in step S005), the routine returns to the step S004 for the user identification procedure. On the other hand, the routine ends if the user 10 does not want to try again the identification procedure (YES in step S005).

When the user identification procedure has succeeded (OK in step S004), the user 10 retrieves digital content data for test-listening or -watching (step S006). The user 10 may enter a password via the entry unit 112 of the order terminal 11 and also listen to several digital content data displayed on the display unit 114 of the order terminal 11 or played via a speaker (not shown), for selection of digital content data.

In detail, once the user 10 performs data retrieval, the content-data searching unit 124 of the server 12 retrieves content data among a lot of digital content data stored in the memory unit 123 and transmits a particular data which seems to be requested by the user 10 to the order terminal 11. The transmitted content data is displayed on the display unit 114 of the order terminal 11. When the order terminal 11 is set at a record shop, for example, the user 10 may select any of digital content data that are being played in the shop with an easy data-selection procedure.

After retrieving and listening to some of digital content data, the user 10 can select any digital content data (step S007). If the requested digital content data has been found (YES in step S007), the routine goes to the next step S008 whereas the routine ends if the requested content data has not been found (NO in step S007). The step S007 is repeated for selection of several digital content data.

When order information such as the contents of the selected digital content data and total charges are displayed on the display unit 114 (step S008), the user 10 checks the order information for purchase procedure (step S009). If the user 10 wants to take the purchase procedure (YES in step S009), the routine goes to step S010 whereas the routine ends if the user 10 does not want to take the purchase procedure (NO in step S009). The routine returns to step S006 when the user 10 wants to select digital content data again (RE-SELECT in step S009) if the selected content data is wrong or another data is requested.

In the purchase procedure (step S010), the user 10 enters necessary information, via the entry unit 112, on settlement and how to obtain the ordered digital content data, etc.

Next, the user 10 decides as to when he or she receives the ordered digital content data (step S011). For later receiving (LATER in step S011), the processor 122 of the server 12 transmits ID information to the order server 11 via the communications unit 122 for issuing with an identifier such as an ID card, an authentication card and a printed material on which ID information are printed (step S012).

On the other hand, the user 10 has to check the user memory 101 for its storage capacity (NOW in step S011) for receiving the ordered digital content data now, receiving a portion of the ordered data now while the remaining data later, or receiving a small amount of compressed data at relatively low quality now while a large amount of uncompressed data at high quality later.

If the user wants to temporarily delete unnecessary data from the user memory 101 (YES in step S013), the user data (unnecessary data) can be uploaded to the memory unit 123 of the server 12 (step S014). An identifier is then issued (step S015) like step S012 for the user 10 to download the deleted data later.

If the storage capacity of the user memory 101 is not enough and also there is no data to be deleted therefrom, re-selection is performed and the routine returns to step S011 for receiving the ordered digital content data later (RE-ELECTION in step S013). On the other hand, if the user memory 101 has an enough storage capacity (NO in step S013), the ordered digital content data is downloaded to the user memory 101 (step S016) and the routine ends. Instead of downloading to the user memory 101, the ordered data may be stored into the memory card 116 of the order terminal When user 10 does not download the unnecessary data that has been transmitted from the user memory 101 to the memory unit 123 of the server 12 within a predetermined period, the unnecessary data may be deleted completely for protecting the user memory 101 from over capacity.

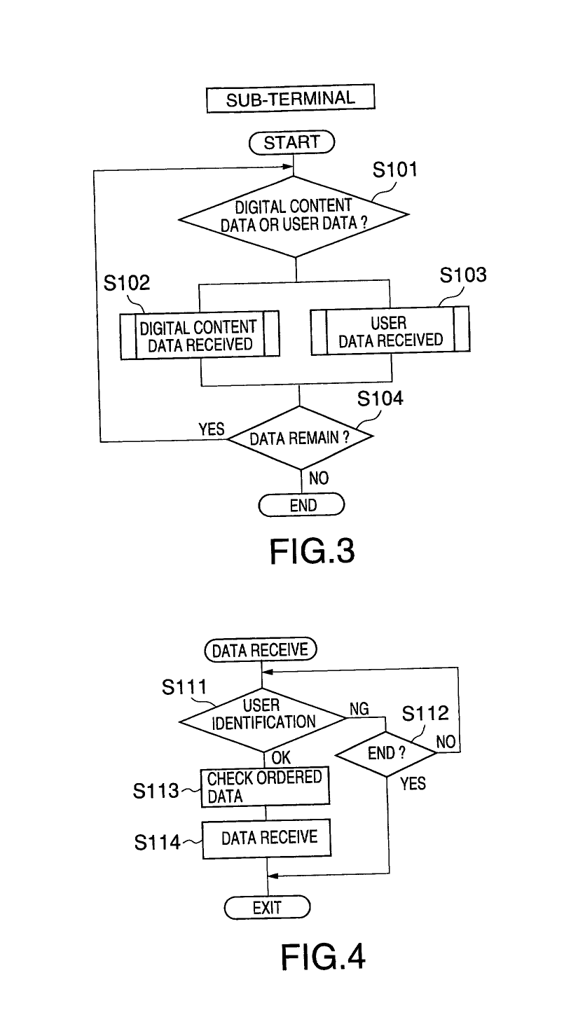

Disclosed next with reference to FIGS. 1 and 3 is a digital-content-data distributing procedure for the user 10 when he or she has not received the ordered content data when placing an order (LATER in step S011 in FIG. 2).

After placing an order via the order terminal 11, the user 10 can have access, anytime, to the processor 122 of the server 12 from the sub-terminal 13 apart from the order terminal 11 via communications between the communications unit 131 and the communications unit 125. The sub-terminal 13 may be the same type as the order terminal 11, but, it is preferable that the memory unit 135 for storing digital content data has a large storage capacity.

In detail, an inquiry is made via the entry unit 133 to check whether the data to be received is the ordered digital content data or unnecessary user data (step S101). The data is received if it is the ordered content data (step S102). Moreover, the data is received if it is the user data (step S103). If data is still remaining (YES in step S104), the routine returns to step S101 for the data-receiving procedure. On the other hand, the routine ends if no data are remaining (NO in step S104).

The data-receiving procedure in steps S102 and S103 are disclosed further in detail with reference to FIG. 4.

The user 10 enters, via the entry unit 113 of the sub-terminal 13, the identifier transmitted from the server 12 in the purchase procedure via the order terminal 11. The processor 122 has access to the user information stored in the memory unit 123 to check whether the identifier is correct for identification of the purchase of digital content data from the server 12 (step S111).

On failure of user identification (NG in step S111), the user 10 determines whether to end the data-receiving procedure (step S112). If so (YES in step S112), the data-receiving procedure ends whereas, if not (NO in step S112), the user 10 tries the user identification again (step S111).

On the other hand, when the user identification has succeeded (OK in step S111), the procedure goes to the next step in which the processor 122 of the server 12 transmits the contents of data ordered by the user 10 to the sub-terminal 13, the contents being displayed on the display unit 134 for the user 10 to check the ordered data (step S113), and the user 10 downloads the digital content data stored in the memory unit 123 of the server 12 (step S114).

User data that has been transmitted to the server 12 temporarily in the purchase procedure for digital content data can also be downloaded through the procedure described above with reference to FIG. 4.

[Second Embodiment]

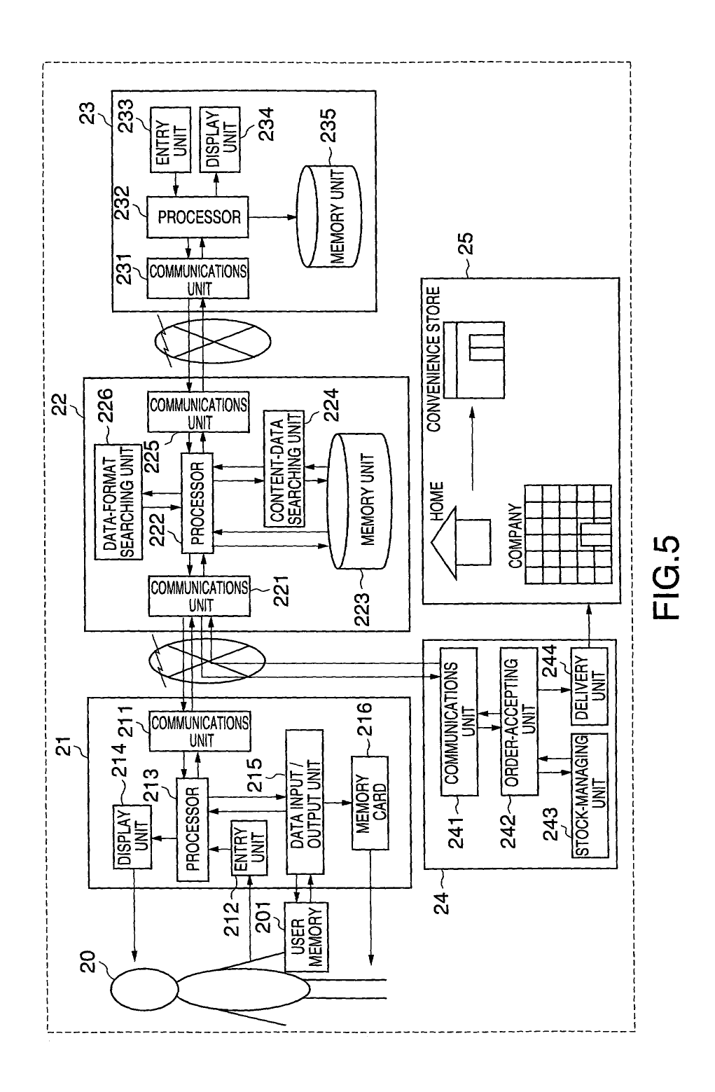

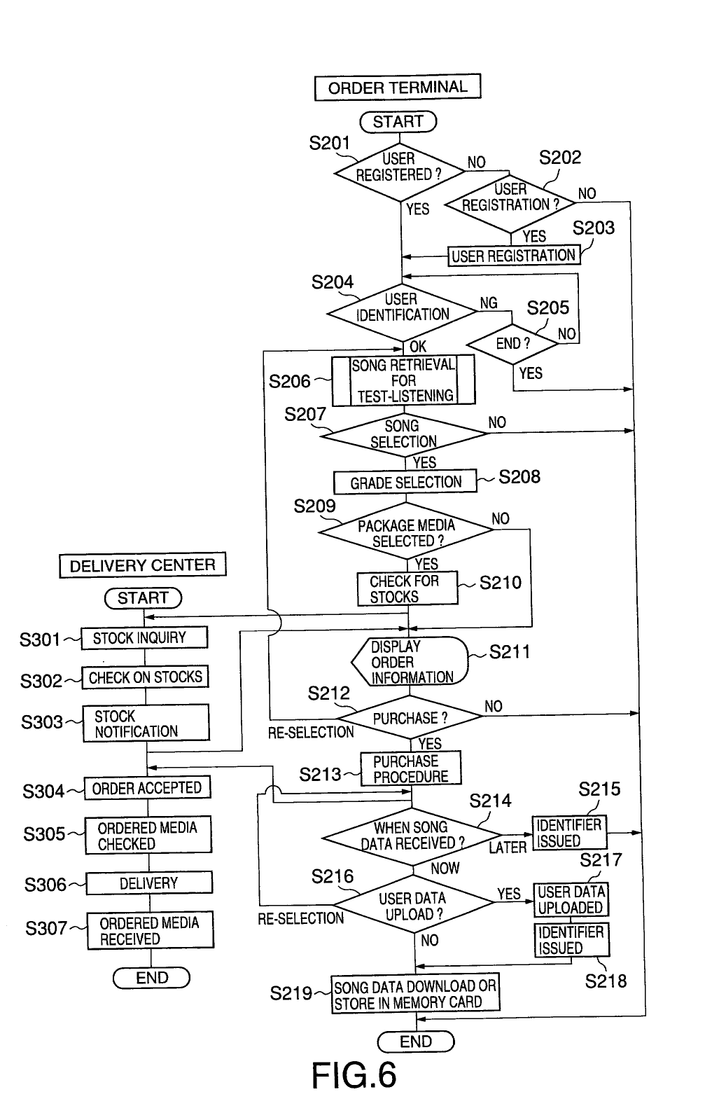

A second embodiment of a content-data distribution system according to the present invention will be disclosed with reference to FIGS. 5 and 6.

In FIG. 5, an order terminal 21 and a sub-terminal 23 have basically the same structure as the order terminal 11 and the sub-terminal 13, respectively, shown in FIG. 1. In detail, a communications unit 211, an entry unit 212, a processor 213, a display unit 214, a data input/output unit 215 and a memory card 216 are equivalent to the communications unit 111, the entry unit 112, the processor 113, the display unit 114, the data input/output unit 115 and the memory card 116, respectively, shown in FIG. 1. A communications unit 231, a processor 232, an entry unit 233, a display unit 234 and a memory unit 235 are equivalent to the communications unit 131, the processor 132, the entry unit 133, the display unit 134 and the memory unit 135, respectively, shown in FIG. 1.

A server 22 at a digital content-data distribution site has a data-format searching unit 226, the other structure being basically the same as the server 12 shown in FIG. 1. In detail, a communications unit 221, a processor 222, a memory unit 223, a content-data searching unit 224 and a communications unit 225 are equivalent to the communications unit 121, the processor 122, the memory unit 123, the content-data searching unit 124 and the communications unit 125, respectively, shown in FIG. 1.

The server 22 is connected to a delivery center 24 via network. The delivery center 24 is provided with a delivery server having an order-accepting unit 242, a stock-managing unit 243 and a delivering unit 244.

A routine for a user 20 to acquire digital content data such as a song via the order terminal 21 set at a record shop, etc., in the second embodiment will be disclosed with reference to FIGS. 5 and 6.

When the user 20 wants to buy a particular digital content data such as a song via the order terminal 21 set a record shop, etc., he or she has access to the server 22 from the order terminal 21 through the communications between communications units 211 and 221. It is checked whether the user 20 has already been registered (step S201).

If registered (YES in step S201), the routine goes to a user identification procedure (step S204). On the other hand, if not registered (NO in step S201), the user 20 decides whether to register or not (step S202).

When the user 20 wants to register (YES in step S202), he or she enters user information, via an entry unit 212, such as a name, a contact address, a credit card number, an ID and a password. The user information is transmitted to the server 22 via a processor 213 and the communications unit 211 and further to a processor 222 via the communications unit 221 for a user registration procedure (step S203) and also the user identification procedure (step S204). The user identification procedure may however be omitted when just after the user registration procedure. The routine ends if the user 20 does not want to register (NO in step S202).

In the user identification procedure (step S204), the user 20 enters user ID information via the entry unit 212 of the order terminal 21. The user ID information is transmitted to the processor 222 of the server 22. The processor 22 has access to a memory unit 223 for a query procedure as to whether the entered user ID information and user information already stored in the memory unit 223 match each other (step S204).

When the user identification procedure has failed (NG in step S204), a message is displayed on a display unit 214 of the order terminal 21 to ask the user 20 whether to end the user identification procedure (step S205). If the user 20 wants to try again the procedure (NO in step S205), the routine returns to the step S204 for the user identification procedure. On the other hand, the routine ends if the user 20 does not want to try again the identification procedure (YES in step S205).

When the user identification procedure has succeeded (OK in step S204), the user 20 retrieves digital song data for test-listening (step S206). The user 20 may enter a password via the entry unit 212 of the order terminal 21 and also listen to several digital song data displayed on the display unit 214 of the order terminal 21 or played via a speaker (not shown), for selection of digital content data.

In detail, once the user 20 performs data retrieval, a content-data searching unit 224 of the server 22 retrieves content data among a lot of digital song data stored in the memory unit 223 and transmits a particular data which seems to be requested by the user 20 to the order terminal 21. The transmitted song data is displayed on the display unit 214 of the order terminal 21. When the order terminal 21 is set at a record shop, for example, the user 20 may select any of digital song data that are being played in the shop with an easy data-selection procedure.

After retrieving and listening to some of digital song data, the user 20 can select any digital song data (step S207). If the requested digital song data has been found (YES in step S207), the routine goes to the next step S208 whereas the routine ends if the requested song data has not been found (NO in step S207). The step S207 is repeated for selection of several digital song data.

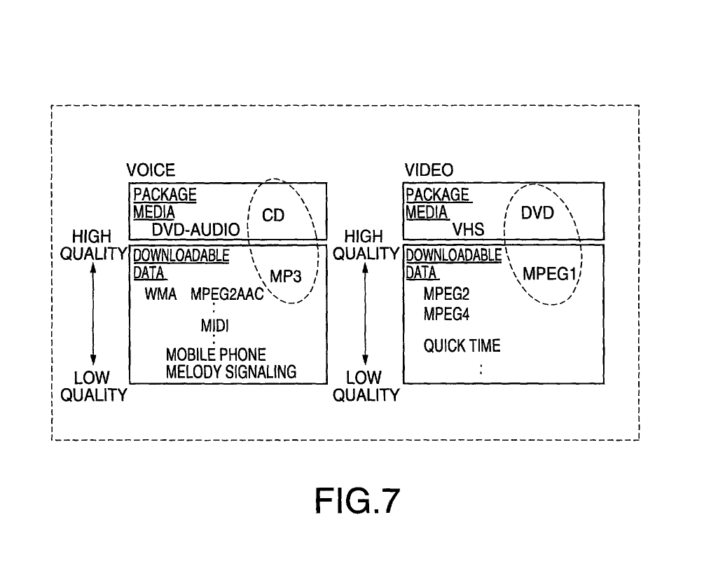

When the user 20 has selected any digital song data (YES in step S207), he or she selects a grade of the selected song data (step S208) from, for example, among grades illustrated in FIG. 7. Songs are stored on package media such as CDs and DVD-Audios. Or, songs are converted into downloadable digital-data format such as MP3, ATRAC and MIDI. The user 20 can select a grade of the selected content data among these grades.

It is checked whether the user 20 has selected package media such as a CD or digital-data media in downloadable digital-data format (step S209). When the user 20 has selected package media (YES in step S209), check is made for stocks (step S210). On the other hand, when the user 20 has selected a downloadable digital-data media (NO in step S209), the routine goes to step S211. Any goods related to the selected digital song data can also be selected (step S209).

When the user 20 has selected a package media (YES in step S209), the routine goes to the following procedure.

The processor 222 of the server 22 has access to an order-accepting unit 242 of the delivery center 24 to make inquiries on stocks and a date of delivery, etc (step S210) via the communications between the communications unit 221 of the server 22 and a communications units 241 of the delivery center 24.

When the order-accepting unit 242 receives the inquiries from the server 22 (step S301), the stock-managing unit 243 makes check on stocks or a date of delivery, etc (step S302) and returns stock notification to the processor 222 of the server 22 (step S303).

After the user 20 has checked out stocks for the selected package media, order information such as the contents of the selected package media and the total charges are displayed on the display unit 214 of the order terminal 21 (step S211). Also displayed on the display unit 214 are in/out of stock and a date of delivery for package media.

The user 20 checks the displayed information for purchase procedure, and if there is something wrong, he or she selects digital song data again (RE-SELECT in step 212) for which the routine returns to step S206. Not only step S206, the routine can return to any of steps S206 to S208.

The routine ends if the user 20 does not want to take the purchase procedure (NO in step S212). On the other hand, the routine goes to step S213 if the user 20 wants to take the purchase procedure (YES in step S212).

In the purchase procedure (step S213), the user 20 enter necessary data, via the entry unit 212, on settlement and how to obtain the ordered digital song data, etc.

Next, the user 20 decides as to when he or she receives the ordered digital song data (step S214). When the user 20 has selected package media, it may also be decided as to where he or she receive the ordered media in step S214. For later receiving (LATER in step S214), the processor 222 of the server 22 transmits ID information to the order server 21 via the communications unit 221 for issuing with identification means such as an ID card, an authentication card and a printed material on which ID information are printed (step S215).

On the other hand, the user 22 has to check the user memory 201 for its storage capacity (NOW in step S214) for receiving the ordered digital song data now, receiving a portion of the ordered data now while the remaining data later, or receiving a small amount of compressed data with relatively low quality now while a large amount of uncompressed data with high quality later.

If the user wants to temporarily delete unnecessary data from the user memory 201 (YES in step S216), the user data (unnecessary data) can be uploaded to and stored in the memory unit 223 of the server 22 (step S217). Identifier is then issued (step S218) like step S215 for the user 20 to download the deleted data later.

If the storage capacity of the user memory 201 is not enough and also there is no data to be deleted therefrom, re-selection is performed and the routine returns to step S214 for receiving the ordered digital song data later (RE-ELECTION in step S216). On the other hand, if the user memory 201 has an enough storage capacity (NO in step S216), the ordered digital song data is downloaded to the user memory 201 (step S219) and the routine ends. Instead of downloading to the user memory 201, the ordered data may be stored into a memory card 216 of the order terminal 21.

When user 20 does not download the unnecessary data that has been transmitted from the user memory 201 to the memory unit 223 of the server 22 within a predetermined period, the unnecessary data may be deleted completely for protecting the user memory 201 from over capacity.

When the purchase procedure has proceeded (step S213), the delivery center 24 accepts an order (step S304) and check the ordered package media for delivery (step S305). The ordered media is delivered by the delivery unit 243 to any place 25 such as the user's home or company, etc, which has been designated by the user 20 in step S214, (steps S306 and S307). The ordered media may also be delivered to a convenience store, so that the user 20 can get the media at the store any time.

Through the routine described above with reference to FIG. 6, the grade selection procedure for digital song data (step S208) could be troublesome to the user 20 due to a complex selection procedure or difficulty in selection if several data formats are available for the song data.

In order to avoid a problem in that the user 20 could download song data in wrong data format, he or she can enter the name of his or her player in hardware or software via the entry unit 212 of the order terminal 21 or an ID information for the player may be automatically transmitted from the order terminal 21 to the server 22. In response to the transmitted information, the data format-searching unit 226 searches data formats available for the user's player, and the searched formats are only displayed on the display unit 214 of the order terminal 21.

Not only that, data formats available for the user's player only can be displayed on the display unit 214 when the user's player has been registered in the user registration procedure (step S203).

Displaying data formats available for the user's player only as described above offers neat displays on the displaying unit 214 of the order terminal 21 for enhanced user-friendly operations.

Moreover, when the user 20 has ordered a set of package and downloadable digital-data media for the same digital song data as indicated by dot circles in FIG. 7 in the grade-selection procedure (step S208), the user 20 can listen to the ordered song immediately even if the ordered package media are out of stock. The ordered package media such as a CD can be delivered later to a place designated by the user 20 in step S214. Not only that, when the order terminal 21 is set at a record shop and the ordered package media are in stock there, the user 20 can get the ordered one at the shop soon after the grade selection procedure. The price of a set of package and downloadable digital-data media for the same digital song data is preferably cheaper than the total price of the package and digital-data media when brought separately.

[Modification to Second Embodiment]

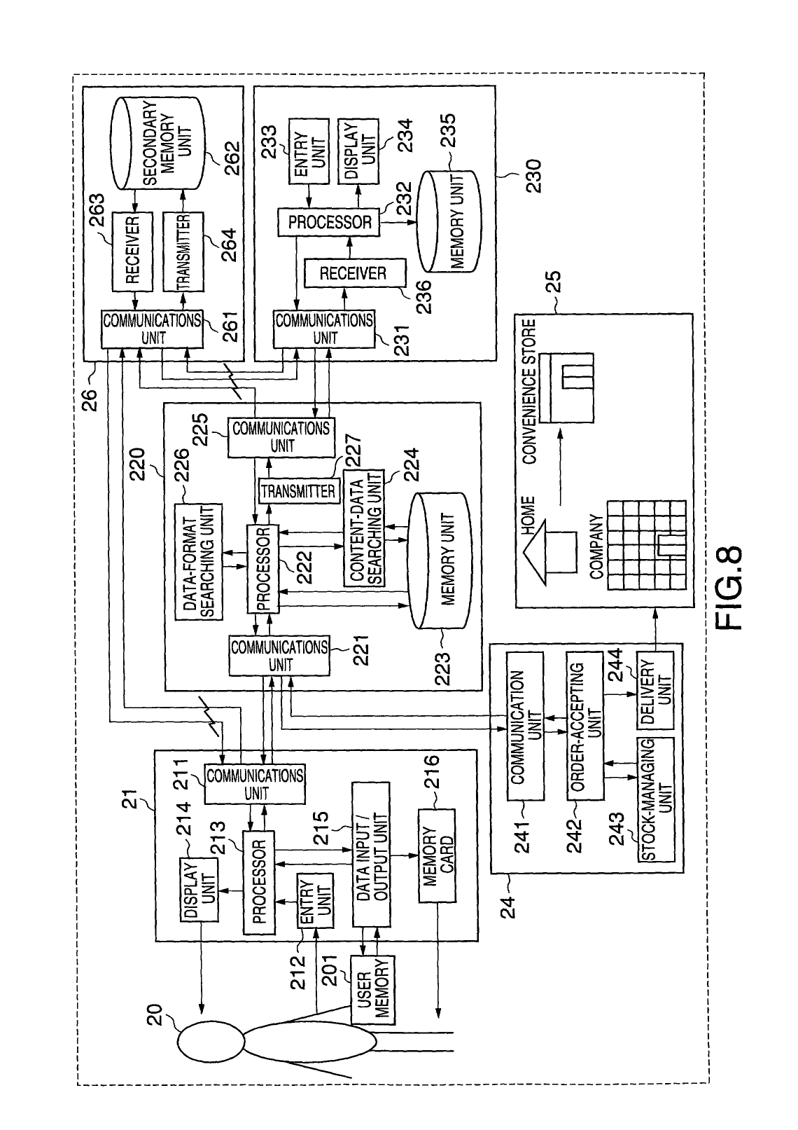

Disclosed next with reference to FIG. 8 is a modification to the second embodiment of a content-data distribution system according to the present invention, provided with a network storage.

Elements in this modification in FIG. 8 that are the same as or analogous to elements shown in FIG. 5 are referenced by the same reference numbers and will not be explained in detail.

A sub-server 26 always or temporarily connected to the network has a secondary memory unit 262 with storage capacity enough for storing digital content data. A user 20 owns a part of or all of the secondary memory unit 262. The sub-server 26 can communicate with a content-data distribution-site server 220 (called main server hereinafter) via communications between communications units 225 and 261.

The main server 220 is equipped with a transmitter 227 for transmitting data to the sub-server 26. The transmitter 227 sends an ordered digital content data to the sub-server 26 when the user 20 designates the sub-server 26 to which the ordered data to be sent in order placement to the main server 220. The sub-server 26 receives the ordered data at its receiver 263 and stores it in the secondary memory unit 262.

The sub-server 26 can communicate with a user terminal (not shown) and also a sub-terminal 230 via communications between communications units 261 and 231. The user 20 can have access to the sub-server 26 anytime via the user terminal or the sub-terminal 230 to download digital content data stored in the secondary memory unit 262. In downloading, a download request is sent from the sub-terminal 230 to the sub-server 26. In response to the download request, sub-server 26 transmits one or more of requested data among the digital content data stored in the secondary memory unit 262 via a transmitter 264 to the sub-terminal 230. The transmitted data is received by a receiver 236 and stored in a memory unit 235.

In this downloading, the ordered digital content data is not sent to a user memory 201, so that the user 20 does not need to check the capacity of the user memory 201, and need not always carry the user memory 201. The user 20 can place an order via an order terminal 21 only through user-friendly operations via an entry unit 212 such as a keyboard or a touch panel.

On the contrary, in case of lack of capacity for the user memory 201 when the user 20 wants to download an ordered digital content data to the user memory 201, he or she can temporarily upload user data already stored in the user memory 201 to the secondary memory unit 262 of the sub-server 26 via the order terminal 21 and/or the main server 220. Any time after downloading the order data to the user memory 201, the user 20 can download the user data from the secondary memory unit 262 to the user memory 201 or the memory unit 235 of the sub-terminal 230.

The user data stored in the user memory 201 can be deleted instead of uploading when it has already been stored in the secondary memory unit 262 of the sub-server 26 because it can be downloaded to the user memory 201 or the memory unit 235 of the sub-server 230 anytime.

As disclosed, communications with the main server 220 and also data delivery can be done in order-placement and purchase procedures by using the secondary memory unit 262 of the sub-server 26. This enables downloading/uploading of ordered digital content data and user data only via communications between the user terminal carried by the user 20 and the secondary memory unit 262.

Moreover, several digital content data ordered at different content distribution sites can be delivered to and stored in the secondary memory unit 262 as a network storage owned by the user 20. This allows the user 20 to download the stored several data freely via communications with the sub-server 26. The sub-server 26 equipped with the secondary memory unit 262 may be the same type as the main server 220 or set inside the main server 220.

[Third Embodiment]

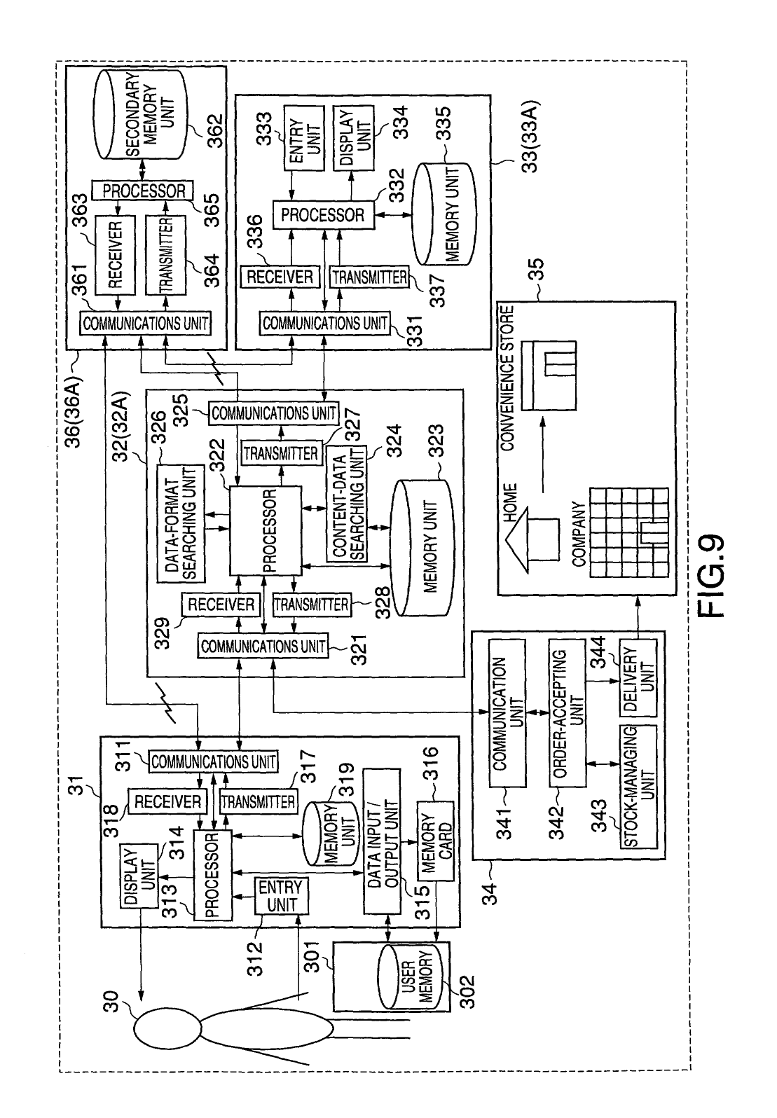

A third embodiment of a content-data distribution system for selling digital content data on package media according to the present invention will be disclosed with reference to FIG. 9.

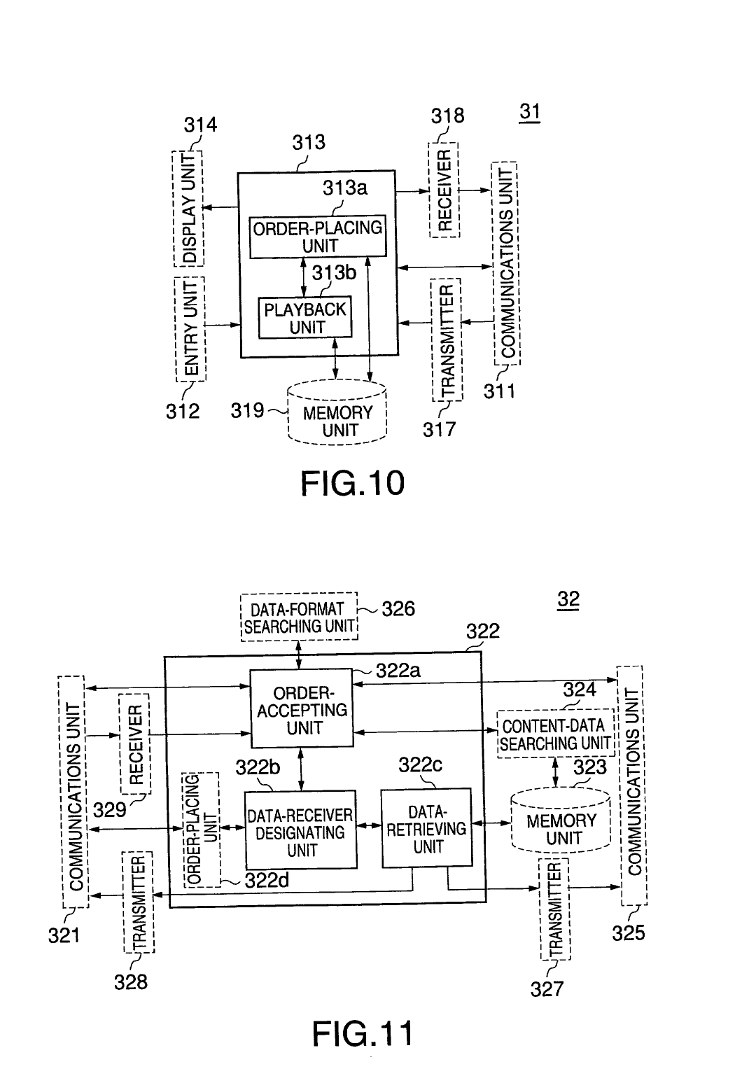

In FIG. 9, an order terminal 31 has a transmitter 317, a receiver 318 and a memory unit 319, the other structure being basically the same as the order terminal 21 shown in FIG. 5, except a processor 313 (FIG. 10). In detail, a communications unit 311, an entry unit 312, a display unit 314, a data input/output unit 315 and a memory card 316 are equivalent to the communications unit 211, the entry unit 212, the display unit 214, the data input/output unit 215 and the memory card 216, respectively, shown in FIG. 5.

A main server 32 has transmitters 327 and 328, and a receiver 329, the other structure being basically the same as the main server 22 shown in FIG. 5, except a processor 322 (FIG. 11). In detail, a communications unit 321, a memory unit 323, a content-data searching unit 324, a communications unit 325 and a data-format searching unit 326 are equivalent to the communications unit 221, the memory unit 223, the content-data searching unit 224, the communications unit 225 and the data-format searching unit 226, respectively, shown in FIG. 5.

A sub-terminal 33 has a receiver 336 and a transmitter 337, the other structure being basically the same as the sub-terminal 13 shown in FIG. 5. In detail, a communications unit 331, a processor 332, an entry unit 333, a display unit 334 and a memory unit 335 are equivalent to the communications unit 231, the processor 232, the entry unit 233, the display unit 234 and the memory unit 235, respectively, shown in FIG. 5.

A sub-server 36 has a processor 365, the other structure being basically the same as the sub-server 26 shown in FIG. 8. In detail, a communications unit 361, a secondary memory unit 362, a receiver 363 and a transmitter 364 are equivalent to the communications unit 261, the secondary memory unit 262, the receiver 263 and the transmitter 264, respectively, shown in FIG. 8.

A delivery center 34 has basically the same structure as the delivery center 24 shown in FIG. 5. In detail, a communications unit 341, an order-accepting unit 342, a stock-managing unit 343 and a delivery unit 344 are equivalent to the communications unit 241, the order-accepting unit 242, the stock-managing unit 243 and the delivery unit 244, respectively, shown in FIG. 5.

Moreover, a place 35 in FIG. 9 includes any place such as the user's home or company, or a convenience store, like the place 25 shown in FIG. 8.

Purchase of digital content data such as music and video as downloadable digital-data media over the network could cause a problem, for example, a long distributing time to a user terminal 301 due to a large amount of high-quality digital data. Another possible problem is shortage of capacity for a user memory 302 attached to the user terminal 301 for storing several long data, etc.

Purchase of digital content data stored on package media such as CDs, MDs, DVDs and memory cards could cause a problem, for example, out of stock at shops. When a user 30 places an order for such package media at shops that do not always keep in stock, via an order terminal set in the street or over the Internet, he or she has to wait for home delivery even if an ordered one is in stock at stockholders.

Moreover, downloading digital content data the same as the one the user 30 wants to buy at Web sites that offer services that he or she can watch or listen to a part of content data could be copyright infringement.

The third embodiment according to the present invention solves such problems in accordance with the following procedures.

When the user 30 wants to buy digital content data either as downloadable digital-data media or package media, or both media, a low-quality small amount of content data (called first data hereinafter) is sent to a user terminal 301 followed by a high-quality large amount of the same content data (called second data hereinafter) sent later to the user terminal 301 or the sub-terminal 33. Instead of downloading, package media storing the second data may be sent to the user 30 by home delivery or the user may buy the package media, if in stock, at a shop at which an order terminal 31 is set.

Sales of digital content data as a set of the downloadable first and second data and package media storing data equivalent to the second data are very convenient for the user 30 because he or she can watch or listen to ordered data in a short time at a low quality though and obtain high-quality data also in a short time or later.

The third embodiment of a content-data distribution system according to the present invention will be disclosed in detail with reference to FIGS. 9 to 12. FIGS. 10 and 11 show block diagrams of the processor 313 of the order terminal 31 and the processor 322 of the main-server 32, respectively.

The content-data distribution system in the third embodiment is a system in which the user 30 places an order for digital content data of songs, etc, as a set of the downloadable first and second data and/or package media storing data equivalent to the second data to the main server 32 (content-data distribution-site server) via the order terminal 31 set a shop or owned by the user 30. The first and the second data compressed at different compression ratios for the same content have been stored in a memory unit 323 of the main server 32.

In placing an order from the order terminal 31 to the main server 32 in FIG. 9, an order request entered by the user 30 via an entry unit 312 is transmitted from an order-placing unit 313a (FIG. 10) of the processor 313 to an order-accepting unit 322a (FIG. 11) of the processor 322 via communications between communications units 311 and 321.

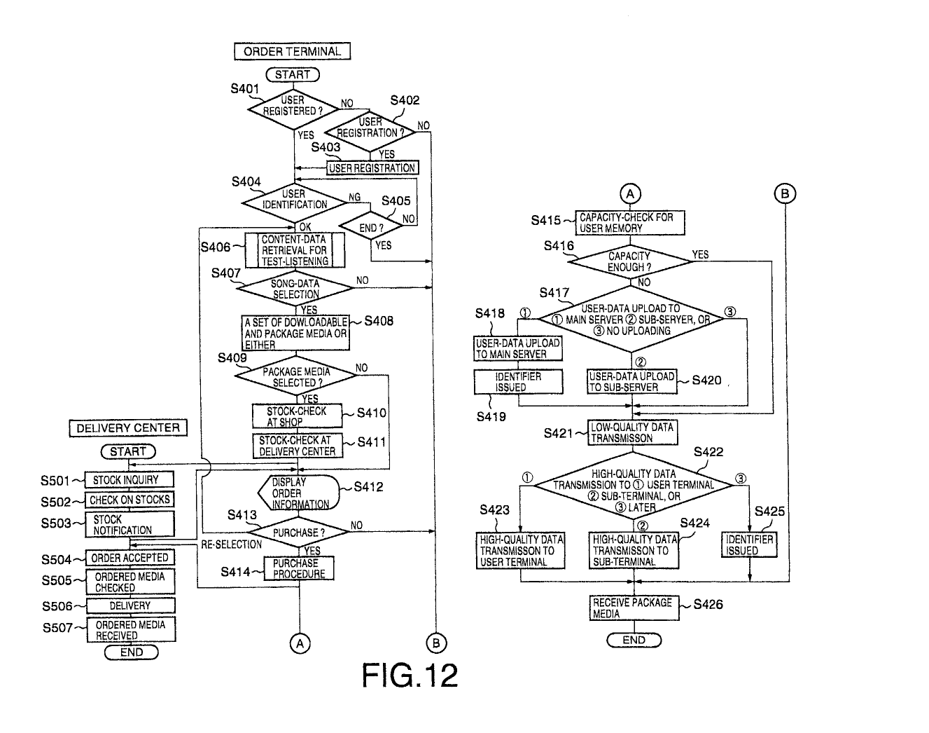

The order-accepting unit 322a has access to a memory unit 323 storing user information to check whether the user 30 has already been registered (step S401 in FIG. 12). If registered (YES in step S401), the routine goes to the next step. On the other hand, if not registered (NO in step S401), the user 30 can tray again from the first step via the entry unit 312 for registration check or decide whether to register or not (step S402).

When the user 30 wants to register (YES in step S402), he or she enters user information, via the entry unit 312, such as a name, a contact address, a credit card number, an ID and a password. The user information is transmitted from the order-placing unit 313a to the order-accepting unit 322a and stored in the memory unit 323 for a user registration procedure (step S403) and also the user identification procedure (step S404). The user identification procedure may however be omitted when just after the user registration procedure. The routine ends if the user 30 does not want to register (NO in step S402).

In the user identification procedure (step S404), the user 30 enters user identification information (ID, password, etc) via the entry unit 312 of the order terminal 31. The user ID information is transmitted to the order-accepting unit 322a of the main server 32. The order-accepting unit 322a has access to the memory unit 323 for a query procedure as to whether the entered user ID information and user information already stored in the memory unit 323 match each other (step S404).

When the user identification procedure has failed (NG in step S404), the order-accepting unit 322a transmits an identification-error information to the order-placing unit 313a. A message is displayed on a display unit 314 of the order terminal 31 to ask the user 30 whether to end the user identification procedure (step S405). If the user 30 wants to try again the procedure (NO in step S405), the routine returns to the step S404 for the user identification procedure. On the other hand, the routine ends if the user 30 does not want to try again the identification procedure (YES in step S405). User information and user ID information may be ciphered in transmission for security. In addition, user information may be sent by mail or fax before user registration.

When the user identification procedure has succeeded (OK in step S404), the user 30 can search for and listen to any digital content data (step S406). The user 30 may enter a keyword (song title, artist name, part of lyrics, etc) via the entry unit 312 of the order terminal 31, the keyword being transmitted from the order-placing unit 313a to the order-accepting unit 322a of the main server 32. The keyword is sent from the order-accepting unit 322a to a content-data searching unit 324.

The content-data searching unit 324 searches for one of more of digital content data from a database (not shown) of the memory unit 323. The searching unit 324 generates content-candidate information that carries one of more of digital content data which seems to be requested or no-entry information that indicates no requested data having been stored. The content-candidate information or the no-entry information is transmitted to the order-placing unit 313a of the order terminal 31. A list of retrieved candidate content data or a no data-entry message is displayed on the display unit 314.

The user 30 looks at the candidate content-data list on the display unit 314 for test-listening to the listed data and/or enters another keyword via the entry unit 312 for re-searching to narrow down candidate content data. And, if requested digital content data is found, the routine goes to a data selection procedure (step S407).

Digital content data on the candidate content-data list for test-listening are a part of content data at quality the same as or lower than those on sale, or entire data of those on sale but at lower quality.

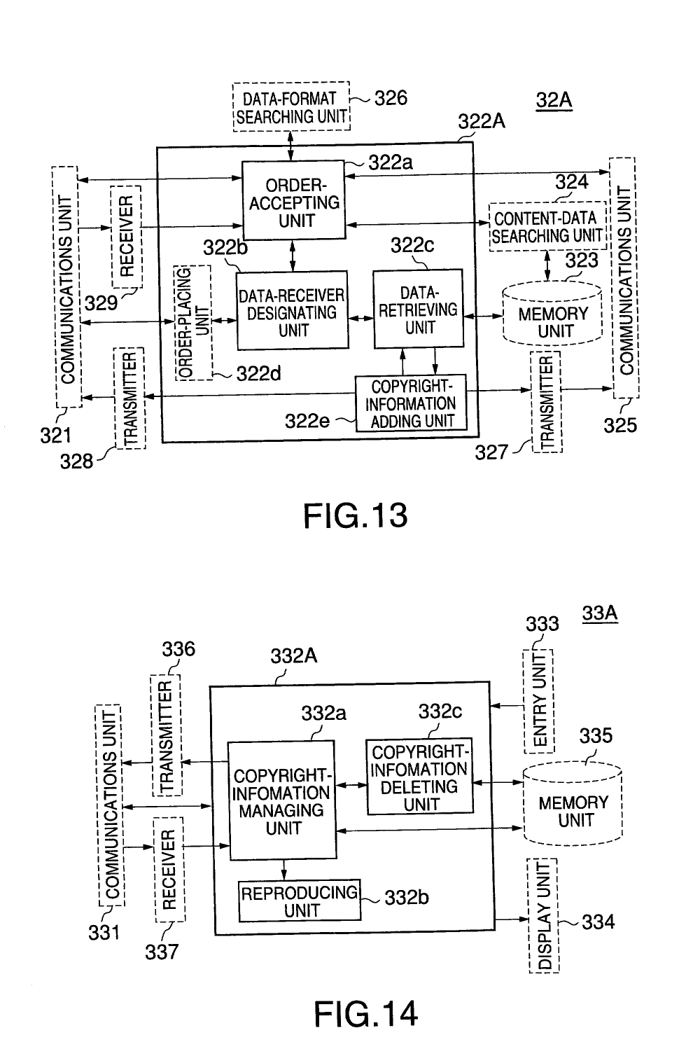

On a test-listening request from the order terminal 31 (step S406), the order-accepting unit 322a sends a command for test-listening of a requested digital content data to a data-receiver designating unit 322b (FIG. 13). The designating unit 322b designates the order terminal 31 as a data receiver and has access to the memory unit 323 via a data-retrieving unit 322c to retrieve digital content data for test-listening. The retrieved content data is transmitted to the order terminal 31 designated as the data receiver via the transmitter 328. The order terminal 31 downloads the transmitted content data via the receiver 318. The downloaded data is reproduced by a playback unit 313b (FIG. 10) and played via a speaker (not shown) for test-listening.

The order terminal 31 may be equipped with a select button, when set a record shop, etc, for selecting a song being played in the shop so that the user 30 can select that song when he or she shows an interest in it. It is also preferable that a menu window is displayed on the display unit 314 with a user-friendly operation to the same purpose.

If the requested digital content data has been found (YES in step S407), the routine goes to the next step S408 whereas the routine ends if the requested content data has not been found (NO in step S407).

When the user 30 has selected digital content data via the entry unit 312, the selected data is transmitted from the order-placing unit 313a to the order-accepting unit 322a. For purchase of a set of the first data (small amount and low quality) and the second data (large amount and high quality), a selection menu is displayed on the display unit 314 for the user 30 to select either downloadable digital-data media or package media or both, via the entry unit 312 (step S408). The entered information is transmitted from the order-placing unit 313a to the order-accepting unit 322a.

The routine goes to step S410 when the user 30 has selected the package media or both of the package and the downloadable digital-data media (YES in step S409). On the other hand, the routine goes to step S412 when the user 30 has selected the downloadable digital-data media only (NO in step S409).

When the user 30 has selected a package medium via the order terminal 31 set at, for example, a CD shop, check is made at a stock-managing database (not shown) for stocks of the selected package media (step S410).

If it is out of stock at the CD shop or due to order placement via the order terminal 31 set in the street, the main server 32 makes an inquiry to the delivery center 34 for stocks when the user 30 wants to get the package media later (step S411).

In detail, on a stock inquiry transmitted from the order-placing unit 313a (FIG. 10) to the order-accepting unit 322a (FIG. 11), it is further sent to the data-receiver designating unit 322b. In response to the stock inquiry, the data-receiver designating unit 322b determines that the order package media will be delivered to a user-designated place later and sends a stock-inquiry command to a order-placing unit 322d.

On receiving the stock-inquiry command, the order-placing unit 322d communicates with an order-accepting unit 342 of the delivery center 34, via communications between communications units 321 and 341, to make inquiries on stocks and a date of delivery, etc (step S411).

When the order-accepting unit 342 receives the inquiries from the order-placing unit 322d (step S501), a stock-managing section 343 makes check on stocks or a date of delivery, etc (step S502) and returns stock notification to the order-placing unit 322d, the notification being transmitted therefrom to the order-placing unit 313a of the order terminal 31 (step S503).

Order information such as selected content names and total charges from the order-placing unit 313a are displayed on the display unit 314 (step S412). In addition, when the user 30 has selected package media, also displayed on the display unit 314 are whether the user 30 can get the package media now or in/out of stock and a date of delivery for the package medium if delivered later based on transmitted the stock notification.

The user 30 checks the order information as to whether something is wrong in the information or the selected package media is a wrong one and can re-try the data selection if needed (RE-SELECTION in step S413) for which the routine returns to step S406. Not only step S406, the routine can return to any of steps S406 to S408.

The routine ends if the user 30 does not want to take the purchase procedure (NO in step S412). On the other hand, the routine goes to step S414 if the user 30 wants to take the purchase procedure (YES in step S413).

In the purchase procedure (step S414), a display command for a settlement procedure and a message on how to receive ordered package media with selection of receiving procedures is sent from the order-placing unit 313a to the display unit 314 for displaying these procedures or message.

In detail, the user 30 operates the entry unit 312 for entry and section on settlement and how to receive the ordered digital content data, etc, with entering necessary information such as an address to which order package media are to be delivered. These entered information are transmitted from the order-placing unit 313a to the order-receiving unit 322a.

In purchase of the second data of high quality such as music in downloadable digital-data media, the user 30 can select either downloading to the user memory 302 of the user terminal 301 or to the second memory unit 362 of the sub-server 36 via later communications between the user terminal 301 or the sub-terminal 33 and the main terminal 32.

Package media can be delivered to any place 35 covered by the delivery center 34, such as user's home, company, a community the user belongs to, a convenience store or another store, or any place the user 30 has designated. The user 30 can obtain the ordered media later at these places or the ordered media can be delivered to the user 30 from these places.

On purchase procedure completion, the user 30 has to check the user memory 302 of the user terminal 301 for its storage capacity (step S415) before downloading the first data of low quality and the second data of high quality when downloadable digital-data media has been selected. The capacity check can be done by comparing the data amount to be downloaded and the storage capacity of the user memory 302 on the display unit 312. Or, via communications between the user terminal 301 and the order terminal 31, the terminal 31 may check the storage capacity of the user memory 302 by comparing it and the data amount to be downloaded.

When the storage capacity of the user memory 302 is enough (YES in step S416), the routine goes to the next step S421. On the other hand, if the user wants to temporarily delete unnecessary data from the user memory 302 (NO in step S416) due to no remaining capacity for the user memory 301 or lack of its capacity for storing the first data and the second data if selected, the user data (unnecessary data) is uploaded to the memory unit 323 of the main server 32 or the secondary memory unit 362 of the sub-server 36 (step S417).

In temporal uploading the user data to the main server 32 (\mathring{1} in step S417), the user data is transmitted from the user terminal 301 to the input/output unit 315 of the order terminal 31 and, via the processor 313, uploaded from the transmitter 317 to the main server 32. The uploaded data is received by the receiver 329 and stored in the memory unit 323 via the processor 322 (step S418).

For later downloading of the user data stored in the memory unit 323 to the user terminal 301 or the sub-terminal 33, the main server 32 transmits, from the order-accepting unit 322a, user ID information such as an ID or a password for user-data downloading, the user ID information being displayed on the display unit 314 of the order terminal 31 or issuing with an identifier such as an ID card, an authentication card and a printed material on which ID information are printed (step S419).

On the other hand, in temporal uploading the user data to the sub-server 36 (\mathring{2} in step S417), the user data is transmitted from the user terminal 301 to the input/output unit 115 of the order terminal 31 and, via the processor 313, uploaded from the transmitter 317 to the sub-server 36. The uploaded data is received by the receiver 363 and stored in the secondary memory unit 362 via the processor 365 (step S420).

When the order terminal 31 does not have an function of communications with the sub-server 36, the user data can be transmitted from the transmitter 317 to the main-server 32. This is received by the receiver 329 and, via the processor 322, uploaded from the transmitter 327 to the sub-server 36. The uploaded data is received by the receiver 363 and stored in the secondary memory unit 362 via the processor 365.

Moreover, when the user 30 does not want to upload the user data because the user memory 302 has an enough storage capacity or the user data may be deleted from the user memory 302 (\mathring{3} in step S417), the routine goes to the next step S421. The user data can, however, be uploaded as described above when the user 30 wants to even if the user memory 302 has an enough storage capacity so that uploading is not necessary.

On completion of capacity check for the user memory 302 and user-data uploading, the first data of low quality of the ordered content data is retrieved from the memory unit 323 by the data-retrieving unit 322c (FIG. 11) and transmitted to the order terminal 31 from the main-server 32 via the transmitter 328.

The first data transmitted to the order terminal 31 is received by the receiver 317, further transmitted from the data input/output unit 315 via the processor 313, to the user terminal 301 and stored in the user memory 302 (step S421).

Next, on selection of the second data of high quality to be downloaded to the user terminal 301 (\mathring{1} in step S422) in the purchase procedure, the second data of ordered content data is retrieved from the memory unit 323 of the main server 32, transmitted to the order terminal 31 and downloaded to the user terminal 301 (step S423), like the first data. The first and the second data can be simultaneously downloaded to the user terminal 301.

On selection of the second data of high quality to be downloaded to the secondary memory unit 362 of the sub-server 36 (\mathring{2} in step S422), the second data is retrieved from the memory unit 323 by the data-retrieving unit 322c and transmitted to the sub-server 36 from the transmitter 327. The transmitted data is received by the receiver 363 and stored in the secondary memory unit 362 (step S424).

Moreover, on selection of the second data to be downloaded later (\mathring{3} in step S417), like the step S419, the main server 32 issues, from the order-accepting unit 322a, with an identifier to the user 30 via the order terminal 31 for downloading the second data later via communications between the user terminal 301 or the sub-terminal 33 and the main server 32 (step S425).

The capacity check for the user memory 302 can be done in selection of how to receive the ordered content data in the purchase procedure (step S414) or before the selection. If the user memory 302 has an enough capacity, the routine can return to the step such as S406, S407 or S408, for selection of other digital content data.

When the ordered package media are in stock at a shop (step S410), the user 30 can receive it at the shop (step S426), and the routine ends.

The user data uploaded to the memory unit 323 of the main server 32 from the user terminal 301 can be deleted for protection of the memory unit 323 from over-capacity when the user data is not downloaded by the user 30 to the user terminal 301 or the sub-terminal 33 for a predetermined period.

Steps S501 to S507 for the delivery center 34 in FIG. 12 are basically the same as steps S301 to S307 shown in FIG. 6, so that the details of these steps are not disclosed for simplicity.

Downloadable digital-data media and package media can be mixed for purchasing several digital content data.

A problem could occur in that the user 30 cannot select a correct data format from among several formats for the ordered digital content data in step S408 or such selection via the order terminal 31 bothers the user 30.

In order to avoid such problems, the user 30 can enter the name of his or her player via the entry unit 312 or select the own player's name displayed on the display unit 314 sent from a player database in the main server 32 or the order terminal 31, a player information on the user player being transmitted to the main server 32. In response to the transmitted information, a data-format searching unit 326 searches data formats available for the user's player. The searched data formats are transmitted to the order terminal 31 and the formats reproducible by the user's player are only displayed on the display unit 314, under user-friendly content-data and format selection procedures.

Not only that, digital content data in the formats reproducible by the user's player only can be displayed on the display unit 314 in the selection procedure (step S408) when the user's player has been registered in the user registration procedure (step S402). This avoids entry of player's name in the purchase procedure while offering a simple content-data selection window on the display unit 314 for enhanced user-friendly operations.

As disclosed above, sales of a set of digital content data at low and high quality in which low-quality data is sent to the user 30 before the high-quality data can meet the user's need in that he or she wants to watch or listen to the content data even if it is of low quality. In addition, since low-quality data is sent to the user 30 very soon, such sales can drive user's eagerness to buy high-quality data. The price of a set of package and downloadable digital-data media for the same digital content data is preferably cheaper than the total price of the package and digital-data media when brought separately.

[Modification to Third Embodiment]

Disclosed next is a modification to the third embodiment of a content-data distribution system for protection of digital content data from copyright infringement according to the present invention.

Distribution of duplicable digital content data from the main server 32 to the sub-server 36 could have a problem even though ID information such as an ID and a password is necessary for access to the sub-server 36. The problem is that such digital content data can be downloaded again and again to the user terminal 301, the sub-terminal 33 owned by the user 30 or another by using the ID information. Such content data distributed from the main server 32 to the user terminal 301 or the sub-terminal 33 can also be copied to another terminal or storage media such as CD-R and MD.

In order to avoid such copyright infringement, a modification to the third embodiment provides a copyright-information-added digital-content data distribution system.

This modification is equipped with a main server 32A, a sub-terminal 33A and a sub-server 36A each having a copyright protector, the other structure being basically the same as the third embodiment (FIG. 9).

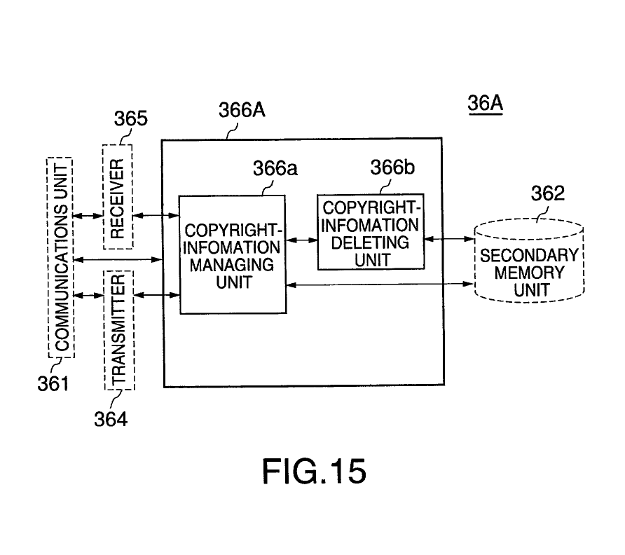

The main server 32A has a processor 322A as shown in FIG. 13. The sub-terminal 33A has a processor 332A as shown in FIG. 14. The sub-server 36A has a processor 366A as shown in FIG. 15. The other structures for the main server 32A, the sub-terminal 33A and the sub-server 36A are basically the same as the counterparts 32, 33 and 36, respectively, shown in FIG. 9.

Before distribution of digital content data from the main server 33A in steps S421 to S424 in FIG. 12 or in generation of digital content data in the main server 33A (before storing them in the memory unit 323), digital content data are added copyright information such as duplication-inhibiting information or duplication-restricting information for the number of content data allowed for duplication, the number of licenses to duplication, duplication just for once or duplication from a first duplicate to form a second duplicate, duplication from the second to form a third duplicate, and so on.

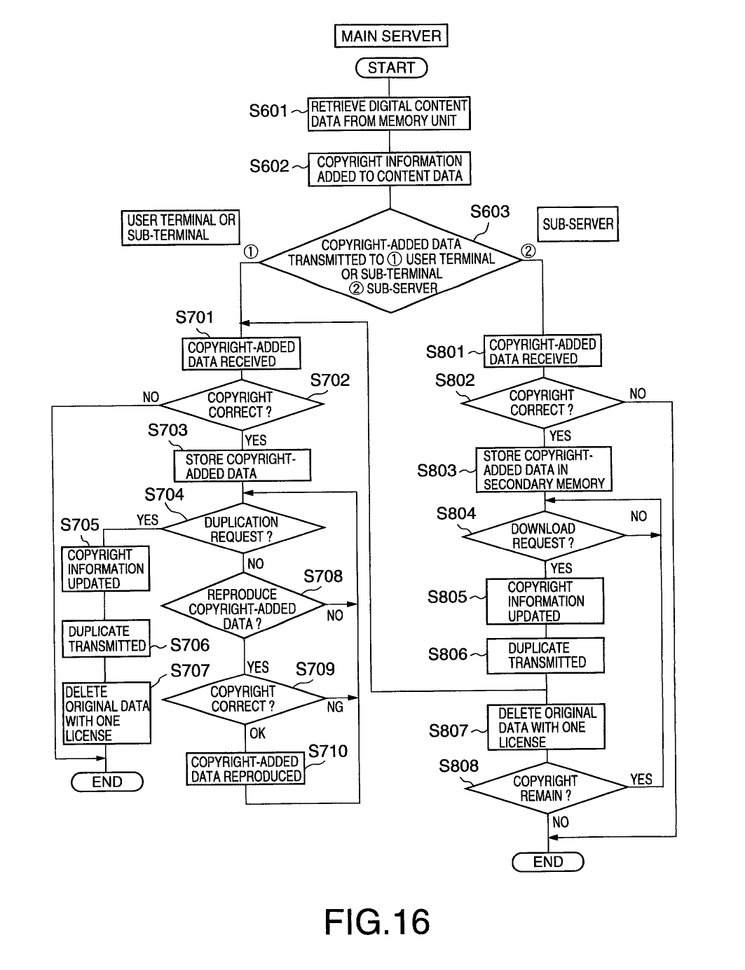

In FIG. 16, after a content-data order has been transmitted from the order terminal 31 to the main server 32A, an ordered content data is retrieved from the memory unit 323 by the data-retrieving unit 322c (step S601). The copyright information described above is added to the retrieved content data by a copyright-information adding unit 322e in FIG. 13 (step S602). The copyright-information-added data is transmitted from the transmitter 328 to a place designated by the data-receiver designating unit 322b, such as, the user terminal 301 or the sub-server 36A (step S603).

Generation of copyright-information-added digital content data before storing in the memory unit 323 restricts the type of copyright information to only one. Therefore, several same data have to be generated for adding several types of copyright information. This requires a lager capacity for the memory unit 323 compared to addition of copyright information at data distribution, nonetheless giving a small burden to the main server 32A with usual formats for content data.

When copyright-information-added content data has been transmitted from the main server 32A to the sub-terminal 33A (\mathring{1} in step S603), the transmitted data is downloaded to the receiver 337 of the sub-terminal 33A (step S701). Such content data may be transmitted to the user terminal 301 instead of the sub-terminal 33A.

The copyright-information-added content data is sent to a copyright-information managing unit 332a (FIG. 14) of the sub-terminal 33A for determining whether the copyright information is correct, or a licensed one or illegal duplication (step S702). When the memory unit 335 of the sub-terminal 33A has already stored the same content data as the copyright-information-added data, these data may be stored separately as different data or only one content data is stored with updating copyright information such that the copyright information for respective data are combined and added to the one content data, like step S705 disclosed later, for saving the capacity of the memory unit 335. The procedure in step S702 is called a check-in procedure hereinafter.

When the copyright information is correct (YES in S702), the copyright-information-added data is stored in the memory unit 335. On the other hand, if it is illegal (NO in S702), the routine ends with no data storing. An error message indicating illegal copyright information may be displayed on the display unit 334 of the sub-terminal 33A.

When a duplication request for digital content data is transmitted to the order terminal 31 or the content data is to be transmitted to the sub-terminal 33A, the sub-server 36A or another storage medium for duplication (YES in step S704), the duplication-requested content data (called original data hereinafter) is retrieved from the memory unit 335 of the sub-terminal 33A and sent to the copyright-information managing unit 332a.

The copyright information is updated (step S705) by the copyright-information managing unit 332a when the number of generation of duplicates to be allowed has been restricted by the copyright-information (for example, the first and the second generation of duplicates only are allowed).

In detail, copyright information to be added to a duplicated digital content data from the original data is updated such that the number of generation of duplicates is deleted by one from that for the original data by a copyright-information deleting unit 332c (FIG. 14). The duplicated data from the original data is the first generation of duplicate and called duplicate data. This updating means, for example, when the original data has been allowed for duplication by the second generation of duplicate (a duplicate of the duplicate data), the duplicate data is allowed for duplication by the first generation (a duplicate of the duplicate data, only once).

Copyright information may also be updated (step S705) such that one or designated number of licenses is added to the copyright information of the duplicate data whereas one or the designated number of licenses is decreased from that of the original data.

The duplicate data with the updated copyright information is transmitted to the terminal or sever that has requested the duplication (step S706). No data is, however, distributed when the copyright information added to the original data indicates no further duplication possible or only one license so that the data is protected from duplication.

The original data stored in the memory unit 335 is deleted by the copyright-information managing unit 332a when it is distributed with only one license (step S707). The procedure from steps S702 to S707 is called a check-out procedure hereinafter.

On the other hand, when there is no duplication request for digital content data (NO in step S704), the routine goes to step S708 in which, when there is a request for reproducing copyright-information-added digital content data (YES in step S708), the data is sent from the memory unit 335 to the copyright-information managing unit 332a. It is determined whether the added copyright information is correct (step S709). If correct (YES in step S709), the data is sent to a reproducing unit 332b and the reproduced data is played via a speaker not shown (step S710) whereas, if not correct (NO in step S709), it is not sent to the reproducing unit 332b. The reproducing unit 332b may be equipped with a copyright-information identifier for identifying the copyright information added to digital content data sent from the memory unit 335 in reproduction without identification by the copyright-information managing unit 332a.

When copyright-information-added content data has been transmitted from the main server 32A to the sub-server 36A (\mathring{2} in step S603), the transmitted data is downloaded to the receiver 363 in FIG. 15 (step S801).

The copyright-information-added content data is sent to a copyright-information managing unit 366a for determining whether the copyright information is correct, or a licensed one or illegal duplication (step S802). If it is correct (YES in step S802), the content data is stored in the secondary memory unit 362 (step S803) whereas the routine ends if it is not correct (NO in step S802).

The sub-server 36A has been in a standby mode until receiving a download request for digital content data from any terminal accessible to the sub-server 36A (step S804). On receiving the download request (YES in step S804), the sub-server 36A performs the check-out procedure (step S805), like the sub-terminal 33A and transmits a duplicate data to the requesting terminal (step S806).

The original data stored in the secondary memory unit 362 is deleted by a copyright-information deleting unit 366b when it is distributed with only one license (step S807).

After distribution of duplicate data, the routine returns to step S804 if a license for digital content data or right of duplication remains in the copyright information added to the original data (YES in step S808). On the other hand, the routine ends if no such license or right remains, or no original data has been stored (NO in step S808).

Copyright information added to original digital content data stored in the memory unit 319 of the order terminal 31 or the secondary memory unit 362 of the sub-server 36A may be updated (called MOVE). In detail, the number of licenses and/or duplication may be increased by that number added to a duplicate data sent to the order terminal 31 or the sub-server 36A for re-storing from the sub-terminal 33A or the user terminal 301. Such copyright-information updating may also be available when digital content data identical to the original data stored in the order terminal 31 or the sub-server 36A is purchased again.

This copyright-information updating saves memory capacity because only one digital data is stored for one content. Several digital data may, however, be stored for the same content according to necessity.

It is preferable to restrict watching or listening to digital content data only via a terminal to which the content data has been downloaded. It is also preferable to restrict a period for reproduction of digital content data duplicated via the main server 32, the sub-terminal 33A, the user terminal 301 or the sub-server 36A.

Copyright-information management that allows “MOVE” only described above achieves efficient management of the number of licenses for several types of storage media to which duplicated digital content data are to be stored.

As disclosed above, users can buy digital content data by downloading the data to their mobile terminals, etc, without worrying about a downloading time and memory capacity of the mobile terminals, via a digital content-data distribution system according to the present invention.

Moreover, according to the present invention, users can buy downloadable digital content data even if package media are out of stock, which meets a demand for watching or listen to the content data soon.

Furthermore, according to the present invention, users can buy digital content data without worrying about data format even if several formats have been provided.

What is claimed is:

1. A digital content-data distribution system comprising:
an order terminal for downloading digital content data in response to order placement made by a user for the digital content data via the order terminal, whether the ordered digital content data be downloaded when the user places an order or later being decided in accordance with a user request and/or capacity of a user memory for storing the ordered digital content data; and
a main server for transmitting the ordered digital content data when the user places an order or later in accordance with the decision.

2. The digital content-data distribution system according to claim 1 further comprising a sub-terminal, the ordered digital content data being downloaded to the order terminal for downloading at the order placement whereas being downloaded to the order terminal or the sub-terminal for downloading later.

3. The digital content-data distribution system according to claim 1, wherein the ordered digital content data is downloaded to the user memory at the order placement while digital content data already stored in the user memory is transferred to a memory of the main server when the user memory lacks capacity for the data to be downloaded.

4. The digital content-data distribution system according to claim 1, wherein the ordered digital content data transmitted by the main server has several data formats, data formats reproducible by the order terminal only being displayed on the order terminal.

5. The digital content-data distribution system according to claim 1, wherein a format of the ordered digital content data is decided in response to entry of a name of user player for reproducing the ordered digital content data.

6. The digital content-data distribution system according to claim 1, wherein the main server has a first transmitter for transmitting the ordered digital content data, the system further comprising a sub-server connected to the main server via a network and a sub-terminal to which the ordered digital content data is downloaded,
wherein the sub-server has a first receiver for receiving the digital content data transmitted by the first transmitter of the main server, a memory for storing the received digital content data and a second transmitter for transmitting the ordered digital content data to the sub-terminal; and
wherein the sub-terminal has a second receiver for receiving the ordered digital content data transmitted from the sub-server and a memory for storing the downloaded digital content data.

7. The digital content-data distribution system according to claim 1, wherein the main server has a first transmitter for transmitting user data, the system further comprising a sub-server connected to the main server via a network and a sub-terminal to which user data is downloaded,
wherein the sub-server has a first receiver for receiving the user data transmitted from the main server, a memory for storing the received user data and a second transmitter for transmitting the user data to the sub-terminal; and
wherein the sub-terminal has a second receiver for receiving the user data transmitted from the sub-server and a memory for storing the downloaded user data.

8. The digital content-data distribution system according to claim 1, wherein the main server has a processor for designating a place to which a storage medium storing the digital content data ordered from the order terminal to the main server and/or goods related to the ordered digital content data are/is to be delivered,
the system further comprising a delivery server connected to the main server via a network, the delivery server having:
an order-accepting unit for accepting an order for the storage medium and/or goods;
a stock-managing unit for managing stock and a date of delivery for the ordered storage medium and/or goods and notifying the order-accepting unit of information on the stock and date of delivery; and
a delivery unit for delivering the ordered storage medium and/or goods to a place designated by the processor of the main server in response to the information sent from the order-accepting unit.

9. The digital content-data distribution system according to claim 1, wherein the main server has a copyright-information adder for adding copyright-information to the digital content data,
the system further comprising:
a sub-server, connected to the main server via a network, for receiving the digital content data transmitted from the main server; and
a sub-terminal for receiving the digital content data transmitted from the main server or the sub-server,
wherein the sub-server includes:
a first receiver for receiving the digital content data transmitted from the main server;
a first copyright-information manager for deciding whether or not the digital content data received by the first receiver has been added the copyright-information; and
a first copyright-information deleter for deleting the digital content data or making the digital content data as un-reproducible when a duplicate of the digital content data is stored in a memory of the sub-server the order terminal,
wherein the sub-terminal includes:
a second receiver for receiving the digital content data transmitted from the main server or the sub-server;
a second copyright-information manager for deciding whether or not the digital content data received by the second receiver has been added the copyright-information;
a reproducer for reproducing the digital content data only when the digital content data has been decided as being added the copyright-information; and
a second copyright-information deleter for deleting the digital content data or making the digital content data as un-reproducible when a duplicate of the digital content data is stored in the memory of the sub-server or the order terminal.

10. A digital content-data distribution system comprising:
an order terminal for downloading digital content data when a user places an order for the digital content data via the order terminal; and
a main server for transmitting the ordered digital content data in response to the order placement via the order terminal,
wherein the main server includes:
a memory for storing N (an integer of two or more) number of digital content data having the same contents but different from each other on compression ratio and/or data format;
an order-accepting unit for accepting the order placement for the digital content data;
a data-retrieving unit, responsive to the order placement, for retrieving the N number of digital content data from the memory and forming a set of the N number of digital content data or retrieving a set of the N number of digital content data from the memory;
a data-receiver designating unit for designating a receiver for receiving the set of the N number of digital content data;
a media-selecting unit for selecting package media and/or downloadable digital-data media for obtaining the ordered set of the N number of digital content data; and
a transmitter for transmitting one or more of the N number of digital content data as the downloadable digital-data media to the order terminal or a sub-terminal when designated as the receiver,
the order terminal includes:
an order-placing unit for placing an order for the package media and/or the downloadable digital-data media to the main server; and
a receiver for receiving the downloadable digital-data media,
the system further comprises a delivery server connected to the main server via a network, the delivery server having:
a communications unit for receiving an order placement from the main server;
an order-accepting unit for accepting an order for the storage media;
a stock-managing unit for managing stock and a date of delivery for the ordered storage media and notifying the order-accepting unit of information on the stock and date of delivery; and
a delivery unit for delivering the ordered storage media to a place designated the order-accepting unit, and
the sub-terminal being connected to the main server via the network, having a receiver for receiving the downloadable digital-data media.

11. The digital content-data distribution system according to claim 10, wherein the main server further includes:
a memory for storing a player database of names of players for reproducing the digital content data and data formats reproducible by the players;
a data-format retrieving unit for retrieving reproducible data formats based on the names of the players;
a communications unit for transmitting information on the retrieved reproducible data formats to the order terminal or the sub-terminal,
wherein the order terminal and the sub-terminal include:
an entry unit for entering a name of a player for reproducing the digital content data:
a communications unit for transmitting the name of the player to the main server and receiving the information on the retrieved reproducible data formats; and
a display unit for displaying the information on the retrieved reproducible data formats.

12. The digital content-data distribution system according to claim 10, wherein the main server has a copyright-information adder for adding copyright-information to the digital content data,
the system further comprising:
a sub-server, connected to the main server via a network, for receiving the digital content data transmitted from the main server; and
a sub-terminal for receiving the digital content data transmitted from the main server or the sub-server,
wherein the sub-server includes:
a first receiver for receiving the digital content data transmitted from the main server;
a first copyright-information manager for deciding whether or not the digital content data received by the first receiver has been added the copyright-information; and
a first copyright-information deleter for deleting the digital content data or making the digital content data as un-reproducible when a duplicate of the digital content data is stored in a memory of the sub-server the order terminal,
wherein the sub-terminal includes:
a second receiver for receiving the digital content data transmitted from the main server or the sub-server;
a second copyright-information manager for deciding whether or not the digital content data received by the second receiver has been added the copyright-information;
a reproducer for reproducing the digital content data only when the digital content data has been decided as being added the copyright-information; and
a second copyright-information deleter for deleting the digital content data or making the digital content data as un-reproducible when a duplicate of the digital content data is stored in the memory of the sub-server or the order terminal.

13. A method of distributing digital content data via communications between an order terminal and a main server comprising the steps of:
deciding whether digital content data be downloaded when a user places an order or later in accordance with a user request and/or capacity of a user memory for storing the digital content data;
transmitting the ordered digital content data from the main server to the order terminal when the user places an order or later in accordance with the decision; and
downloading the transmitted digital content to the order terminal.

14. The method of distributing digital content data according to claim 13 further comprising the step of downloading the ordered digital content data to the order terminal for downloading at the order placement whereas to the order terminal or a sub-terminal for downloading later.

15. The method of distributing digital content data according to claim 13 further comprising the step of downloading the ordered digital content data to the user memory at the order placement while transferring digital content data already stored in the user memory to a memory of the main server when the user memory lacks capacity for the data to be downloaded.

16. The method of distributing digital content data according to claim 13 further comprising the step of displaying only data formats reproducible by the order terminal for the ordered digital content data in several data formats.

17. The method of distributing digital content data according to claim 13 further comprising the step of deciding a format of the ordered digital content data in response to entry of a name of user player for reproducing the ordered digital content data.

18. The method of distributing digital content data according to claim 13 further comprising the step of:
designating a place to which a storage medium storing the ordered digital content data and/or goods related to the ordered digital content data are/is to be delivered;
accepting an order for the storage medium and/or goods;
managing stock and a date of delivery for the ordered storage medium and/or goods;
notifying information on the stock and date of delivery; and
delivering the ordered storage medium and/or goods to the designated place in response to the information.

19. The method of distributing digital content data according to claim 13, wherein the main server is connected to a sub-server via a network, the digital content data being also downloadable to a sub-terminal from the main server or the sub-server, the method further comprising the steps of:
adding copyright-information to the digital content data;
at the sub-server side,
receiving the digital content data transmitted from the main server;
deciding whether or not the received digital content data has been added the copyright-information; and
deleting the digital content data or making the digital content data as un-reproducible when a duplicate of the digital content data is stored in a memory of the sub-server or the order terminal, and
at the sub-terminal side,
receiving the digital content data transmitted from the main server or the sub-server;
deciding whether or not the received digital content data has been added the copyright-information;
reproducing the digital content data only when the digital content data has been decided as being added the copyright-information; and
deleting the digital content data or making the digital content data as un-reproducible when a duplicate of the digital content data is stored in the memory of the sub-server or the order terminal.

20. A method of distributing digital content data via communications between an order terminal and a main server comprising the steps of:
storing N (an integer of two or more) number of digital content data having the same contents but different from each other on compression ratio and/or data format in a memory;
accepting an order placement for the digital content data;
retrieving the N number of digital content data from the memory in response to the order placement to form a set of the N number of digital content data or retrieve a set of the N number of digital content data from the memory;
designating a receiver for receiving the set of the N number of digital content data; and
transmitting one or more of the N number of digital content data to the order terminal or a sub-terminal when designated as the receiver.

21. The method of distributing digital content data according to claim 20 further comprising the steps of:
selecting package media and/or downloadable digital-data media for obtaining the ordered set of the N number of digital content data;
placing an order for the package media and/or the downloadable digital-data media to the main server;
transmitting one or more of the N number of digital content data as the downloadable digital-data media to the order terminal or the sub-terminal when designated as the receiver;
accepting an order for the storage media;
managing stock and a date of delivery for the ordered storage media;
notifying information on the stock and date of delivery; and
delivering the ordered storage media to a place designated the order-accepting unit.

22. The method of distributing digital content data according to claim 20 further comprising the steps of:
storing a player database of names of players for reproducing the digital content data and data formats reproducible by the players;
retrieving reproducible data formats based on the names of the players;
transmitting information on the retrieved reproducible data formats to the order terminal or the sub-terminal,
entering a name of a player for reproducing the digital content data;
transmitting the name of the player to the main server and receiving the information on the retrieved reproducible data formats; and
displaying the information on the retrieved reproducible data formats.

23. The method of distributing digital content data according to claim 20, wherein the main server is connected to a sub-server via a network, the digital content data being also downloadable to a sub-terminal from the main server or the sub-server, the method further comprising the steps of:
adding copyright-information to the digital content data;
at the sub-server side,
receiving the digital content data transmitted from the main server;
deciding whether or not the received digital content data has been added the copyright-information; and
deleting the digital content data or making the digital content data as un-reproducible when a duplicate of the digital content data is stored in a memory of the sub-server or the order terminal, and
at the sub-terminal side,
receiving the digital content data transmitted from the main server or the sub-server;
deciding whether or not the received digital content data has been added the copyright-information;
reproducing the digital content data only when the digital content data has been decided as being added the copyright-information; and
deleting the digital content data or making the digital content data as un-reproducible when a duplicate of the digital content data is stored in the memory of the sub-server or the order terminal.
